(19) United States
(12) Patent Application Publication
(10) Pub. No.: US 2006/0055855 A1
(43) Pub. Date: Mar. 16, 2006

(54) Retarder film, polarizer with built-in retarder, and LCD device having the polarizer

(75) Inventors: Hong Wei Duz, Pingzhen City (TW); Chang Ching Sen, Pingzhen City (TW); Wu Long Hai, Pingzhen City (TW)

Correspondence Address: TROXELL LAW OFFICE PLLC, SUITE 1404, 5205 LEESBURG PIKE, FALLS CHURCH, VA, 22041, US

(73) Assignee: OPTIMAX Technology Corporation

(21) Appl. No.: 11/212,877

(22) Filed: Aug. 29, 2005

(30) Foreign Application Priority Data
Sep. 15, 2004 (TW) 093127936

(51) Int. Cl. G02F 1/1335

(52) U.S. Cl. 349/117

(57) ABSTRACT

A polarizer with built-in retarder is accomplished by employing the retarder directly inside the polarizer to replace one of the transparent substrates of the polarizer, such that the polarizer is substantially built-in with the retarder. Not only the polarizer has larger visible ranges and better displaying quality because of the effect of optic compensation, the thickness of the polarizer is also smaller, and its transparency and optic characteristics are better than prior art polarizer.

### BACKGROUND OF INVENTION

1. Field of the Invention

The present invention relates to a retarder film, polarizer with built-in retarder, and liquid crystal display device, in particular a kind of polarizer structure directly built in with retarder film containing a light retardation layer that provides dual compensation for visual range and chromatic polarization, and its process.

2. Description of the Prior Art

Liquid crystal display (LCD) is now used by all kinds of electronic devices, such as television, computer, mobile handset, and personal digital assistant (PDA). Due to its characteristics of fast response and high contrast ratio of direct viewing angle, thin-film resistor LCD (TFT-LCD) has become the mainstream LCD technology.

FIG. 1A depicts the sectional view of a conventional LCD 10, which typically comprises a liquid crystal element 11 and two polarizers 12, 13 disposed respectively on each surface of liquid crystal element 11. The liquid crystal element 11 is constituted by a glass substrate and a plurality of liquid crystal particles adhered to both surfaces of the glass substrate. Polarizer 12 (or 13) is made of a polarizing film 123 (or 133) sandwiched between two transparent substrates 121, 122 (or 131, 132) that provides compensation for polarization.

If we look at the contrast curve of the visible range of conventional LCD 10 (FIG. 1A) as shown in FIG. 1B, it is clear that conventional LCD offers good visual effect in vertical and horizontal directions only. At 45° or 135° angle, the contrast ratio drops and the hues shift, which seriously affects the display quality of LCD.

Later on LCDs are added with a retarder film to enhance the visual effect of oblique angles. FIG. 2 shows the sectional view of a conventional LCD 20 laminated with a retarder plate 24. The retarder plate 24 is adhered between a top surface of the liquid crystal element 21 and the polarizer 22. The retarder plate 24 consists of a transparent substrate 241 and one or multiple layers of phase retarders 242, 243. The phase retarder works to retard certain wavelengths at predetermined angles and directions, thereby improving the oblique-angle display quality of LCD. Similarly, the two polarizers 22 and 23 disposed on top and bottom of liquid crystal element 21 are made of a polarizing film 223, 233 sandwiched between two transparent substrates 221, 222, 231, 232. For example, U.S. Pat. No. 6,717,642 discloses a technology of improving the visible angle and display quality of LCD by adding a retarder plate.

In the prior art LCD 20 as shown in FIG. 2, the polarizers 22, 23, and the retarder plate 24 are separately produced and then adhesively laminated together. In light that the separately produced polarizers 22, 23 and retarder plate 24 require respectively at least one transparent substrate 222, 232, 241 to provide adequate structural strength and rigidity, and polarizers 22, 23 more so need at least two transparent substrates 221, 222, 231, 232 to achieve protection for polarizing films 223 and 233 and the effect of scratch resistance. However, the use of many substrates and the presence of many lamination layers increase the thickness of LCD and affect adversely its transparency and optic characteristics.

### SUMMARY OF INVENTION

The primary object of the present invention is to provide a retarder film, which is formed by applying a light retardation layer on a transparent polymer film and satisfies the following conditional formulas:
220 nm>Ro(a)+Ro(b)>0.1 nm
−270 nm<Rth(a)+Rth(b)<110 nm
−300 nm<Rth(a)<−10 nm

where Ro(a) and Rth(a) are respectively the in-plane retardation (Ro) and out-of-plane retardation (Rth) of light retardation layer 3142; Ro(b) and Rth(b) are respectively the Ro and Rth of transparent polymer film 3141; nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

Another object of the present invention is to provide a polarizer with built-in retarder, which is accomplished by directly employing a retarder film containing light retardation material to replace one of the transparent substrates. As such, the polarizer achieves better visible range and display quality due to the effect of optic compensation, and is reduced in thickness with at least one less layer of transparent substrate, hence offering better transparency and optic characteristics.

Yet another object of the present invention is to provide a liquid crystal device, comprising a polarizer with built-in retarder. By constructing a plurality of light retardation layers with specific orientation in the structure of polarizer, the liquid crystal display device will exhibit better visible range. Even from an oblique viewing angle of 45 degree or 135 degree, the liquid crystal display device also offers better contrast and color performance.

To achieve the aforesaid objects, the present invention provides a retarder film and a polarizer with built-in retarder, which comprises a first transparent substrate, a polarizing film, and at least a retarder film, the first transparent substrate being made of triacetyl cellulose (TAC) plate to provide strength and rigidity to the polarizer structure.

The polarizing film is a polyvinyl alcohol (PVA) film, which provides polarizing effect. The retarder film is directly disposed on a surface of the polarizing film. Therefore, the first transparent substrate, polarizing film and retarder film together constitute one body. The retarder film is made of a transparent polymer film with light retardation material formed thereon.

### BRIEF DESCRIPTION OF THE DRAWINGS

The details of the present invention will be more readily understood from a detailed description of the preferred embodiments taken in conjunction with the following figures.

FIG. 1A shows the sectional view of a conventional LCD.

FIG. 1B shows the contrast curve of the visible range of conventional LCD in FIG. 1A.

FIG. 2 shows the sectional view of a conventional LCD added with a retarder plate.

FIG. 3 shows the sectional view of an embodiment of retarder film according to the present invention.

FIG. 4A shows the sectional view of polarizer with built-in retarder in the first embodiment according to the present invention.

FIG. 4B shows the contrast curve of visible range of polarizer with built-in retarder in the first embodiment as shown in FIG. 4A.

FIG. 5A shows the sectional view of polarizer with built-in retarder in the second embodiment according to the present invention.

FIG. 5B shows the contrast curve of visible range of polarizer with built-in retarder in the second embodiment as shown in FIG. 5A.

FIG. 6A shows the sectional view of polarizer with built-in retarder in the third embodiment according to the present invention.

FIG. 6B shows the contrast curve of visible range of polarizer with built-in retarder (31c) in the third embodiment as shown in FIG. 6A.

FIG. 7 shows the sectional view of polarizer with built-in retarder in the fourth embodiment according to the present invention.

### DETAILED DESCRIPTION

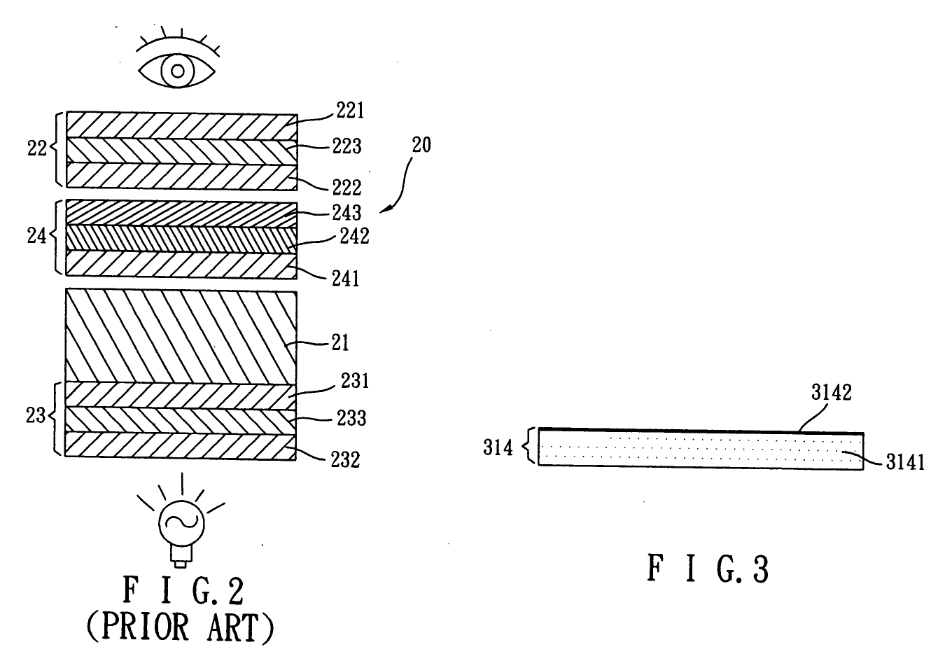

FIG. 3 depicts the sectional view of an embodiment of retarder film 314 according to the present invention. By disposing a light retardation layer 3142 on a transparent polymer film 3141, the resulting film can retard specific wavelengths at predetermined angles and directions to achieve the purpose of compensating the display quality of LCD from oblique viewing angles. In this embodiment, the polymer film 3141 is transparent polymer film commonly used in the industry and preferably thermoplastic resin, and more preferably thermoplastic resin with excellent mechanical strength, moisture penetrability, transparency, thermal stability and optic characteristics. Examples of this kind of transparent polymer film include cellulose resin, such as triacetyl cellulose, propionyl cellulose, and transparent resin, such as polyamide, polycarbonate, polyester, polystyrene, polyacrylate, norbornene-based polymer, and polyethyl acetate. In consideration of the optic characteristics and weather resistance properties (heat, moisture, etc.) of the polarizer, triacetyl cellulose (TAC) that has been surface treated with alkaline and saponified is the preferred choice.

In this embodiment, the transparent polymer film 3141 and the light retardation layer 3142 respectively satisfies the following optic conditional formulas:
220 nm>Ro(a)+Ro(b)>0.1 nm
−270 nm<Rth(a)+Rth(b)<110 nm
−300 nm<Rth(a)<−10 nm

where Ro(a) and Rth(a) are respectively the in-plane retardation (Ro) and out-of-plane retardation (Rth) of light retardation layer 3142; Ro(b) and Rth(b) are respectively the Ro and Rth of transparent polymer film 3141; nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

Retarder film 314 made according to the aforesaid conditional formulas is commonly referred to as C-plate in the industry. After retarder film 314 is built into the polarizer, it provides light retardation effect of predetermined angles and directions to achieve the purposes of optic compensation and improvement of visible range and display quality. Because the retarder film 314 of the present invention can provide support and protection for the polarizing film in polarizer, it can be directly built inside the polarizer to replace one of the transparent substrates originally disposed on the side of polarizer, thereby reducing the overall thickness of polarizer (for at least one less transparent substrate is used as compared to prior art) and enhancing its optic characteristics. Below are detailed descriptions of the implementation method.

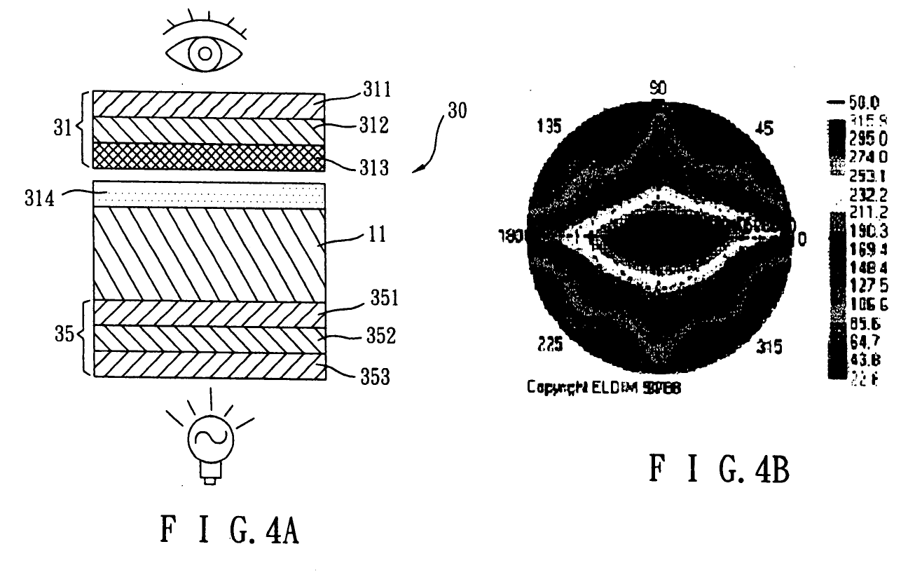

FIG. 4A and FIG. 4B are respectively sectional view of polarizer 31 with built-in retarder in the first embodiment of the invention and the contrast curve of visible range of polarizer 31 with built-in retarder in the first embodiment as shown in FIG. 4A.

As shown in FIG. 4A, the polarizer 31 with built-in retarder may be used in conjunction with a liquid crystal element 32. In this embodiment, the liquid crystal element 32 is an in-plane switching (IPS) LCD element. It can also be a MVA LCD or TN LCD element. The composition and functions of liquid crystal element 32 are not elaborated here for it is a prior art and not a major feature of the invention. The polarizer 31 with built-in retarder film 314 comprises mainly a first transparent substrate 311, a first polarizing film 312, a first phase retarder 313 and the retarder film 314. The first transparent substrate 311 is made of triacetyl cellulose (TAC), which has sufficient structural strength and rigidity to support the entire polarizer 31 and protect the first polarizing film 312 from scratch. The first polarizing film 312 is a polyvinyl alcohol (PVA) film. The first polarizing film 312 has specific polarizing effect and is prepared by stretching the PVA film after it is absorbed with iodine or dichromatic substance, such as dichromatic dye. Because the composition and effects of the first transparent substrate 311 and the first polarizing film 312 are the same as the prior art, their composition and effects are not elaborated here.

The main feature of this embodiment is that the first phase retarder 313 is directly built inside the polarizer 31. The first phase retarder 313 is also an optic compensation film, only its optic characteristics and process are different from those of retarder film 314. As shown in FIG. 4, the first phase retarder 313 is directly formed on the first polarizing film 312 such that the first transparent substrate 311, first polarizing film 312 and first phase retarder 313 are in one body, and the first transparent substrate 311 and the first phase retarder 313 respectively constitutes a protective layer on the two opposing surfaces of first polarizing film 312. Thus the polarizer 31 comprised of first phase retarder 313, first polarizing film 312 and first transparent substrate 311 is a single element that stands independently and can be independently sold, preserved and shipped. In this embodiment, the retarder film 314 is made of transparent polymer film 3141 with a light retardation layer 3142 formed thereon as shown in FIG. 3, and the retarder film 314 and polarizer 31 built in with a first phase retarder 313 are laminated in sequence onto liquid crystal element 32.

The first phase retarder 313 and retarder film 314 can retard wavelengths at predetermined angles and directions, thereby improving the oblique angle display quality of LCD 30. In this embodiment, the first phase retarder 313 is a polymer film (called A-Plate) that satisfies the conditions of nx>ny=nz and 60 nm<Ro<250 nm. That is, the first phase retarder 313 acts as an optical compensation film, also a protective layer. The optic conditions for retarder film 314 (C-Plate) have been described earlier and will not be reiterated here.

Polarizer 31 with built-in retarder can be disposed on the top surface (the side with an eye in the figure) or the bottom surface (the side with a light bulb in the figure) of liquid crystal element 32. In the embodiment as shown in FIG. 4A, polarizer 31 with built-in retarder is superimposed over the top surface of liquid crystal element 32, while the bottom surface of liquid crystal element 32 is adhered with a polarizing plate 35 of prior art consisting of a second polarizing film 352 sandwiched between a third transparent substrate 351 and a fourth transparent substrate 353. Generally, the polarizing directions of the first polarizing film 312 and the second polarizing film 352 are perpendicular to each other.

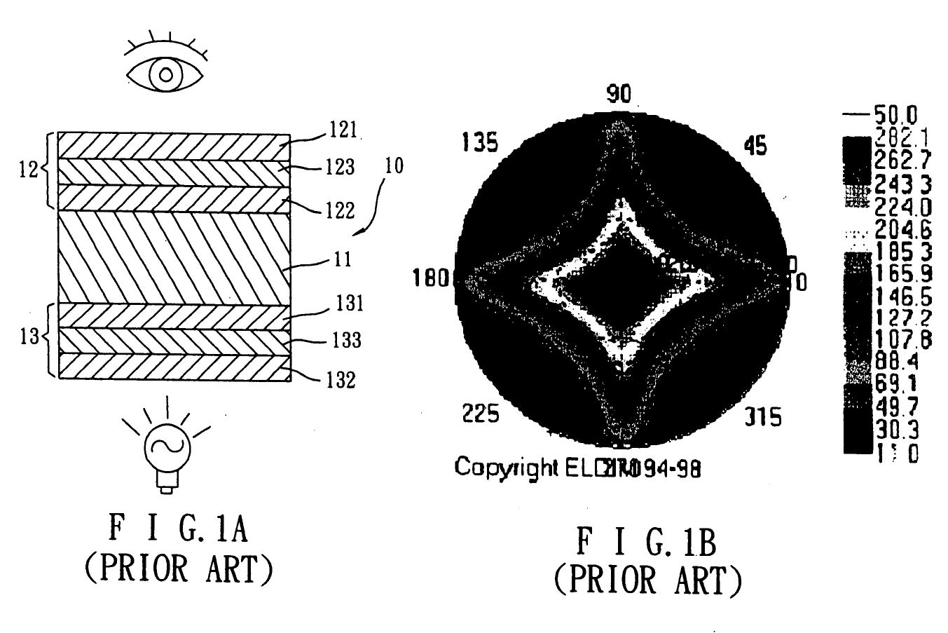

As shown in FIG. 4A and FIG. 4B, the polarizer 31 with built-in retarder in LCD 30 contains a first phase retarder 313 (A-Plate) and a retarder film 314 (C-Plate). In comparison with the contrast curve of conventional polarizer 12, 13 (FIG. 1B) which is free of retarder, the polarizer 31 with built-in retarder as disclosed herein provides better contrast and color performance in terms of visible range from oblique angle (as shown in FIG. 4B), and achieves the effect of optic compensation. Also, in comparison with prior art polarizer 22 and prior art LCD 20 with retarder as shown in FIG. 2, the polarizer 31 with built-in retarder disclosed herein uses at least one less transparent substrate, which not only reduces its thickness, but also improves its transparency and optic characteristics.

The other embodiments of the invention to be described have basically the same or similar elements as the embodiment described above. Thus those elements are given the same numbers with an English alphabet suffix for distinction purpose and their compositions will not be elaborated again.

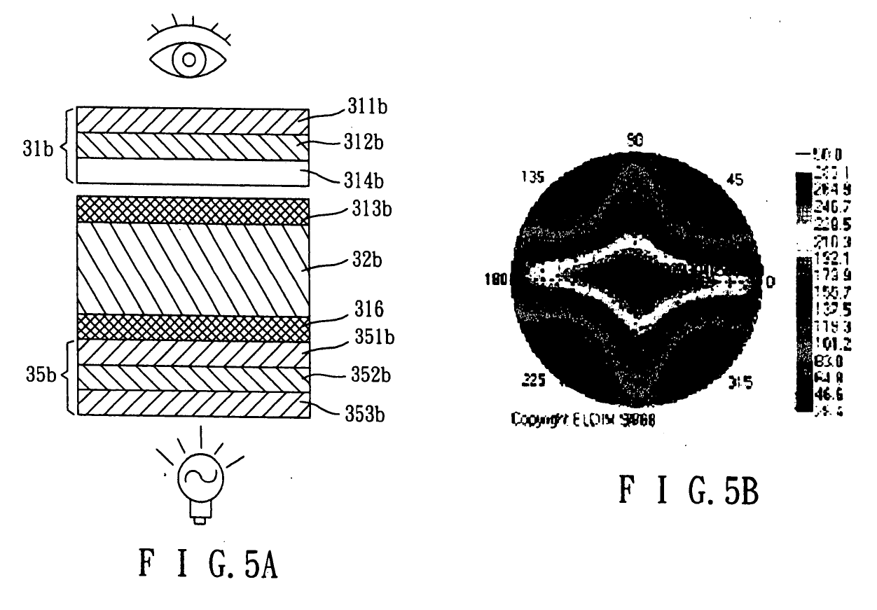

FIG. 5A and FIG. 5B are respectively sectional view of polarizer 31b with built-in retarder in the second embodiment of the invention and the contrast curve of visible range of polarizer 31b with built-in retarder in the second embodiment as shown in FIG. 5A. In this embodiment, a first polarizing film 312b is sandwiched between a first transparent substrate 311b and a retarder film 314 (C-Plate), and the side of retarder film 314b formed with light retardation material faces down (i.e. away from the first polarizing film 312b). As such, the polarizer 31b with built-in retarder is in one body consisting of the first transparent substrate 311b, the first polarizing film 312b and the retarder film 314b. Furthermore, the first phase retarder 313b (A-Plate) is adhesively disposed on the bottom surface (i.e., the side having the retarder film 314b) of polarizer 31b, which is then adhered to the top surface of liquid crystal element 32b. In this second embodiment, a second phase retarder 316 (A-Plate) is formed on the surface of a third transparent substrate 351b, and a second polarizing film 352b is sandwiched between the third transparent substrate 351b and the fourth transparent substrate 353b, where the second phase retarder 316, the third transparent substrate 351b, the second polarizing film 352b and the fourth transparent substrate 353b together form another polarizer 35b with built-in retarder disposed on the bottom surface of liquid crystal element 32b.

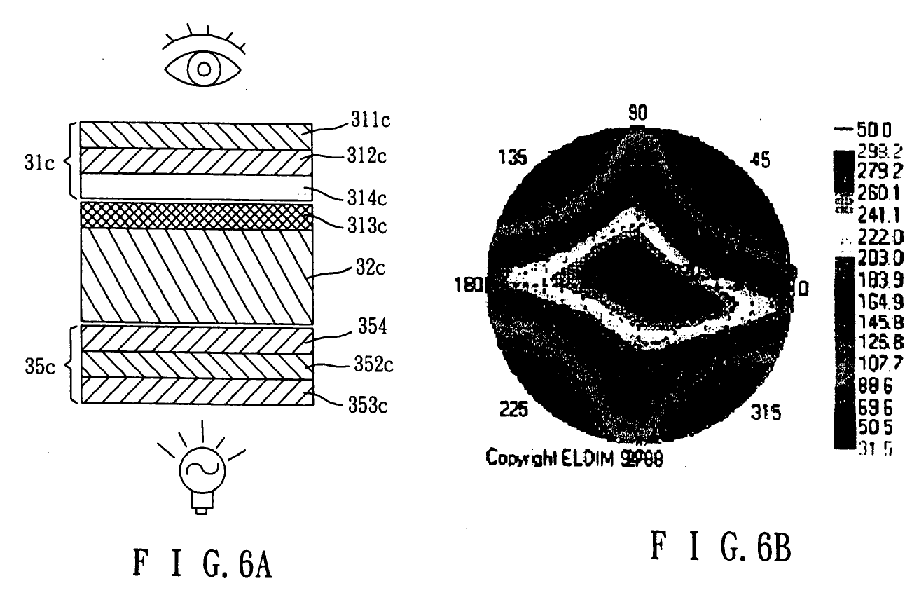

FIG. 6A and FIG. 6B are respectively sectional view of polarizer 31cwith built-in retarder in the third embodiment of the invention and the contrast curve of visible range of polarizer 31c with built-in retarder in the third embodiment as shown in FIG. 6A. In this embodiment, a first polarizing film 312c is sandwiched between a first transparent substrate 311c and a retarder film 314c (C-Plate) to form a polarizer 31c. The side of retarder film 314c formed with light retardation material faces down. A first phase retarder 313c (A-Plate) is formed on the bottom surface of retarder 314c in one body with polarizer 31c, which is subsequently adhered to the top surface of liquid crystal element 32c. Also in this embodiment, on the bottom surface of liquid crystal element 32c, there are disposed of in sequence: a transparent substrate 354, a second polarizing film 352c, and a fourth transparent substrate 353c. Said transparent substrate 354 in particular is a transparent polymer substrate with low birefringence, which may be a cyclic olefin polymer (COP), cyclic olefin copolymer (COC) or metallocene catalyzed cyclic olefin copolymer (mCOC) having lower phase difference, i.e. its Ro and Rth approximate zero.

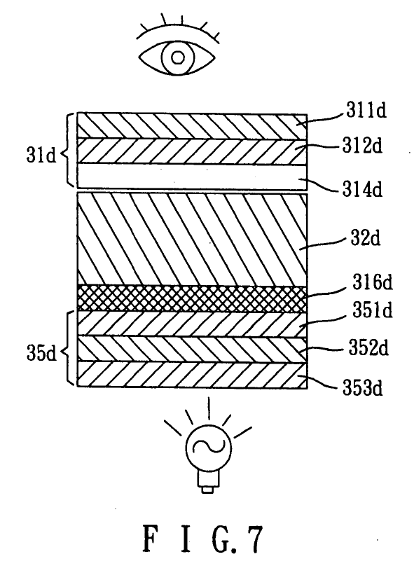

FIG. 7 is a sectional view of polarizer 31d with built-in retarder in the fourth embodiment of the present invention, where a first polarizing film 312d is sandwiched between a first transparent substrate 311d and a retarder film 314d (C-Plate) and forms into one body with polarizer 31d. Furthermore, polarizer 31d is adhered to the top surface of liquid crystal element 32d. On the bottom surface of liquid crystal element, there are in sequence a second phase retarder 316d (A-Plate), a third transparent substrate 351d, a second polarizing film 352d, and a fourth transparent substrate 353d.

Preferred embodiments of the present invention have been disclosed in the examples. However the descriptions made in the examples should not be construed as a limitation on the actual applicable scope of the present invention, and as such, all modifications and alterations without departing from the spirits of the invention shall be deemed as further embodiment of the invention and remain within the protected scope and claims of the invention.

What is claimed is:

1. A retarder film, comprising:
a transparent polymer film having at least one light retardation layer thereon, wherein the transparent polymer film and the light retardation layer respectively satisfies the following optic conditional formulas:
220 nm>Ro(a)+Ro(b)>0.1 nm; and
−270 nm<Rth(a)+Rth(b)<110 nm;
where Ro(a) and Rth(a) are respectively the in-plane retardation (Ro) and out-of-plane retardation (Rth) of light retardation layer; Ro(b) and Rth(b) are respectively the Ro and Rth of transparent polymer film;
and nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

2. The retarder film according to claim 1, wherein the light retardation layer of retarder film further satisfies the following optic conditional formula:
−300 nm<Rth(a)<−10 nm.

3. The retarder film according to claim 1, wherein said transparent polymer film is selected from a group of transparent resin materials consisting of triacetyl cellulose, propionyl celluose, polyamide, polycarbonate, polyester, polystyrene, polyacrylate, norbornene-based polymer, and polyethyl acetate.

4. A polarizer built in with retarder, comprising:
a first transparent substate for providing structural strength and rigidity to the polarizer;
a poloarizing film formed on the first transparent substrate; and
a retarder film consisting of a transparent polymer film having at least one light retardation layer formed thereon;
wherein said transparent polymer film and light retardation layer respectively satisfies the following optic conditional formulas:
220 nm>Ro(a)+Ro(b)>0.1 nm; and
−270 nm<Rth(a)+Rth(b)<110 nm;
where Ro(a) and Rth(a) are respectively the in-plane retardation (Ro) and out-of-plane retardation (Rth) of light retardation layer; Ro(b) and Rth(b) are respectively the Ro and Rth of transparent polymer film;
and nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

5. The polarizer according to claim 4, wherein said retarder film is directly disposed on the polarizing film such that the first transparent substrate, polarizing film and retarder film together constitute one body.

6. The polarizer according to claim 4, wherein said light retardation layer of retarder film further satisfies the following optic conditional formula:
−300 nm<Rth(a)<−10 nm.

7. The polarizer according to claim 4, wherein said first transparent substrate is made of TAC plate containing triacetyl cellulose.

8. The polarizer according to claim 4, wehrein said polarizing film is a PVA film containing polyvinyl alcohol.

9. The polarizer according to claim 4, wherein said polarizer further contains a first phase retarder, the first phase retarder being a polymer film satisfying the condition of nx>ny=nz.

10. The polarizer according to claim 9, wherein said first phase retarder satisifies the condition of 60 nm<Ro<250 nm.

11. The polarizer according to claim 4, wherein said first transaprent substrate and retarder film respectively constitutes a protective layer on the two opposing surfaces of polarizer.

12. A polarizer built in with retarder, characterized in which a polarizing film is formed on a first transparent substrate and at least a retarder film is directly disposed on the other surface of the first transparent substrate opposite to the polarizing film, wherein the retarder film can act as a protective layer for the polarizing film.

13. The polarizer according to claim 12, wherein said retarder film consists of a transparent polymer film having at least one light retardation layer formed thereon;
wherein said transparent polymer film and light retardation layer respectively satisfies the following optic conditional formulas:
220 nm>Ro(a)+Ro(b)>0.1 nm; and
−270 nm<Rth(a)+Rth(b)<110 nm;
where Ro(a) and Rth(a) are respectively the in-plane retardation (Ro) and out-of-plane retardation (Rth) of light retardation layer; Ro(b) and Rth(b) are respectively the Ro and Rth of transparent polymer film;
and nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

14. The polarizer according to claim 13, wherein said light retardation layer of retarder film further satisfies the following optic conditional formula:
−300 nm<Rth(a)<−10 nm.

15. The polarizer according to claim 12, wherein said first transparent substrate is made of TAC plate containing triacetyl cellulose.

16. The polarizer according to claim 12, wehrein said polarizing film is a PVA film containing polyvinyl alcohol.

17. The polarizer according to claim 12, wherein said polarizer further contains a first phase retarder, the first phase retarder being a polymer film satisfying the condition of nx>ny=nz.

18. The polarizer according to claim 17, wherein said first phase retarder satisifies the condition of 60 nm<Ro<250 nm.

19. The polarizer according to claim 12, wherein said first transaprent substrate and retarder film respectively constitutes a protective layer on the two opposing surfaces of polarizer.

20. The polarizer according to claim 12, wherein said first transparent substrate, polarizing film and retarder film are in one body for form a single element.

21. A liquid crystal display device, comprising:
a liquid crystal element having a top surface and a bottom surface; and
a first polarizer built in with retarder which is adhered to the top surface of the liquid crystal element, the polarizer further comprising:
a first transparent substate for providing structural strength and rigidity to the polarizer;
a poloarizing film formed on the first transparent substrate; and
a retarder film directly formed on the polarizing film such that the first transparent substrate, polarizing film and retarder film together constitute one body.

22. The liquid crystal display device according to claim 21, wherein said retarder film consists of a transparent polymer film having at least one light retardation layer formed thereon;
wherein said transparent polymer film and light retardation layer respectively satisfies the following optic conditional formulas:
220 nm>Ro(a)+Ro(b)>0.1 nm; and
−270 nm<Rth(a)+Rth(b)<110 nm;
where Ro(a) and Rth(a) are respectively the in-plane retardation (Ro) and out-of-plane retardation (Rth) of light retardation layer; Ro(b) and Rth(b) are respectively the Ro and Rth of transparent polymer film; and nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

23. The liquid crystal display device according to claim 22, wherein said light retardation layer of retarder film further satisfies the following optic conditional formula:
−300 nm<Rth(a)<−10 nm.

24. The liquid crystal display device according to claim 21, wherein said first transparent substrate is made of TAC plate containing triacetyl cellulose.

25. The liquid crystal display device according to claim 21, wherein said polarizing film is a PVA film containing polyvinyl alcohol.

26. The liquid crystal display device according to claim 25, wherein the liquid crystal display device further contains a first phase retarder, the first phase retarder being a polymer film satisfying the condition of nx>ny=nz.

27. The liquid crystal display device according to claim 26, wherein said first phase retarder satisifies the condition of 60 nm<Ro<250 nm.

28. The liquid crystal display device according to claim 21, wherein the bottom surface of liquid crystal element contains a second polarizer.

29. The liquid crystal display device according to claim 28, wherein said second polarizer consists of at least two transparent substrates and a polarizing film sandwiched in between.

30. The liquid crystal display device according to claim 29, wherein a second phase retarder lies between the bottom surface of liquid crystal element and the second polarizer.

31. The liquid crystal display device according to claim 30, wherein said second phase retarder is a polymer film satisfying the condition of nx>ny=nz and the condition of 60 nm<Ro<250 nm.

32. A liquid crystal display device, comprising:
a liquid crystal element having a top surface and a bottom surface; and
a polarizer disposed on either the top surface or bottom surface of the liquid crystal element, and the polarizer further comprising:
a first transparent substate for providing structural strength and rigidity to the polarizer;
a poloarizing film formed on the first transparent substrate; and
a retarder film consisting of a transparent polymer film having at least one light retardation layer formed thereon;
wherein said transparent polymer film and light retardation layer respectively satisfies the following optic conditional formulas:
220 nm>Ro(a)+Ro(b)>0.1 nm; and
−270 nm<Rth(a)+Rth(b)<110 nm;
where Ro(a) and Rth(a) are respectively the in-plane retardation (Ro) and out-of-plane retardation (Rth) of light retardation layer; Ro(b) and Rth(b) are respectively the Ro and Rth of transparent polymer film; and nx denotes the refractive index along x-axis of surface; ny denotes the refractive index along y-axis of surface; nz is thicknesswise refractive index along z-axis; Ro=(nx−ny)*d; Rth={(nx+ny)/2−nz}*d; and d is film thickness.

33. The liquid crystal display device according to claim 32, wherein said light retardation layer of retarder film further satisfies the following optic conditional formula:
−300 nm<Rth(a)<−10 nm.

34. The liquid crystal display device according to claim 32, wherein said retarder film is directly disposed on the polarizing film such that the first transparent substrate, polarizing film and retarder film together constitute one body.
